(19) United States
(12) Patent Application Publication
(10) Pub. No.: US 2024/0052160 A1
(43) Pub. Date: Feb. 15, 2024

(54) OPEN CELLED FLEXIBLE POLYURETHANE FOAM HAVING IMPROVED SELF-EXTINGUISHING FIRE TEST PERFORMANCE

(71) Applicant: Dow Global Technologies LLC, Midland, MI (US)

(72) Inventors: Antonio Papa, Emilia (IT); Giuliano Guidetti, (US); Sabrina Fregni, (US)

(21) Appl. No.: 17/907,335

(22) PCT Filed: Jun. 2, 2021
(86) PCT No.: PCT/US2021/035334

§ 371 Date: Oct. 30, 2023

(30) Foreign Application Priority Data
Jun. 5, 2020 (IT) 102020000013318

(51) Int. Cl. C08L 75/04; C08G 18/76; C08G 18/79; C08G 18/12; C08G 18/18; C08G 18/20; C08K 5/523; C08J 9/12

(52) U.S. Cl. CPC C08L 75/04; C08G 18/7671; C08G 18/794; C08G 18/797; C08G 18/12; C08G 18/1833; C08G 18/2063; C08K 5/523; C08J 9/125; C08G 2101/00

(57) ABSTRACT

The present invention provides self-extinguishing flexible polyurethane foams, reaction mixtures and methods for making them, wherein the foam forming reaction mixture comprises an isocyanate component of one or more aromatic polyisocyanate containing two or more aromatic or phenyl groups, and an aromatic phosphorus containing flame retardant, and, separately, a polyol component which is a mixture of one or more, first polyols and one or more high molecular weight polyols, and from 7.5 to 17.5 wt. %, based on the weight of the polyol component, of a brominated polyether flame retardant having a bromine content of from 30 to 40 wt. %, and having an average hydroxyl functionality of from 2.3 to 3.5, one or more catalysts, and one or more blowing agents. The flexible polyurethane foam has a gross density of from 200 to 280 g/l.

The present invention relates to reaction mixtures for making open celled flexible polyurethane foams, the open celled foams therefrom and methods of making them. More particularly, it relates to fire resistant flexible polyurethane foam forming reaction mixtures which contain liquid flame retardant compositions, are substantially free of solid flame retardants, and that exhibit good self-extinguishing and physical properties, and the methods of making them wherein a reaction mixture for making the flexible polyurethane foams comprises a polyol component that contains an hydroxyl functional brominated polyol having an average hydroxyl functionality of from 2.3 to 3.5 and polyisocyanate component that contains a triphenyl phosphate compound.

### BACKGROUND OF THE INVENTION

Known flexible polyurethane foams are flammable and generally melt and drip when exposed to flames, leading to the spread of burning drips. Further, the flexible polyurethane foams may smolder after the flames have been extinguished. Recently, several automakers have issued more demanding self-extinguishing fire tests for flexible polyurethane foams use for engine encapsulation, for example, the Volkswagen PV 3357 fire test. The new self-extinguishing fire tests determine burning behavior resulting from surface and edge flame exposure, measuring the response of the foam to the fire after the ignition source is removed. The flexible polyurethane foam must not continue to burn once the flame is removed, which means it must be self-extinguishing; and any dripping flexible polyurethane foam must not continue to burn.

Of known flexible polyurethane foams, the only ones that pass the self-extinguishing fire test contain a solid fire retardant, such as expandable graphite. However, such solid flame retardants cannot be processed without additional processing equipment. For example, expandable graphite has acid in its chemical structure and so may reduce the reactivity of a polyol component with isocyanate. To address this acidification problem, makers of flexible polyurethane foams use dedicated mixing heads and high pressure pumps equipped with filters for oversized solids. However, many producers of flexible polyurethane foams for automotive uses have one foam making line to produce parts for different original equipment manufacturers (OEMs).

In addition, flexible polyurethane foams used in an engine compartment encasement have to comply with acoustic specifications for sound absorbing performance to reduce the noise coming from an engine. The use of the solid flame retardant compositions can negatively affect the acoustic performance of the foam. Therefore, there remains a need for a flexible polyurethane foams for engine encapsulation that are free of solid flame retardants while meeting self-extinguishing and acoustic specifications, as well as physical property requirements including each of compression stress resistance (DIN EN ISO 3386-1), tensile strength (DIN EN ISO 1798) and 50% compression set (DIN EN ISO 1856), both initially and after heat and/or humidity exposure.

Recently, World Intellectual Property Organization (WIPO) publication WO2019204625A1, to FRX Polymers Inc., discloses flexible polyurethane foams comprising halogen-free flame retardant compositions that may deliver some physical properties called for in automotive engine compartment encasement. However, the FRX polymers flexible polyurethane foam fails to enable acceptable self-extinguishing fire resistance, for example, for use in the engine compartments of vehicles.

The present inventors have endeavored to provide flexible polyurethane foam forming reaction mixtures that comprise a liquid flame retardant and enable provision of flexible polyurethane foams that meet all of the current self-extinguishing and physical property specifications of a major automotive manufacturer.

### SUMMARY OF THE INVENTION

In accordance with the present invention a flexible polyurethane foam forming reaction mixture comprises an isocyanate component of one or more aromatic polyisocyanate containing two or more aromatic or phenyl groups, or a prepolymer thereof, and from 12 to 27 wt. %, or, preferably, from 14 to 25 wt. %, based on the weight of the isocyanate component, of an aromatic phosphorus containing flame retardant, preferably, a triaryl phosphorous containing flame retardant containing three phenyl or aromatic groups, and, further, comprises a polyol component which is a mixture of one or more, preferably, two or more, first polyols having an average of from 2.4 to 3.5 hydroxyl groups and a hydroxyl number according to ASTM D4274 of from 26 to 44 mg KOH/g, or, for example, from 30 to mg KOH/g, or, from 32 to 37 mg KOH/g), for example, an ethylene oxide (EO) endcapped triol (e.g. glycerine) initiated propoxylated polyol, and one or more high molecular weight polyols having an average of from 1.8 to 6, or, preferably, from 3 to 5.2 hydroxyl groups and a hydroxyl number according to ASTM D4274 of from 27 to 38 mg KOH/g, or, for example, 31 to 34 mg KOH/g, for example, an EO endcapped triol and sugar alcohol initiated propoxylated polyether polyol, and a flame retardant in the amount of from 7.5 to 17.5 wt. %, or, preferably, from 9 to 16.5 wt. %, based on the weight of the polyol component, of a flame retardant halogenated polyether polyol, preferably, a brominated polyether flame retardant having a bromine content of from 30 to 40 wt. % and an average hydroxyl functionality of from 2.3 to 3.5, one or more catalysts, and one or more blowing agents, preferably, water. The total amount of the one or more blowing agents may range from 1.0 to 2.0 wt. %, or, preferably, from 1.1 to 1.3 wt. %, based on the total weight of the polyol component of the reaction mixture. The relative amounts of the isocyanate component and the polyol component in the reaction mixture may be sufficient to provide an isocyanate index of from 0.86 to 1.15 or, preferably, from 0.89 to 1.12, or, more preferably, from 0.89 to 1.11.

In accordance with the foam forming reaction mixture of the present invention, wherein the isocyanate component may comprise diphenylmethane diisocyanate (MDI) in the form of its 2,4′-, 2,2′-, or 4,4′-isomers (monomeric MDI), a polymeric MDI which is a uretonimine, allophanate, biuret, or isocyanurate of MDI, an MDI prepolymer, such as one made from a diol chain extender and one or more of an MDI and polymeric MDI, or mixtures thereof, preferably, a mixture of, or a prepolymer made from 40 to 60 wt. %, based on the weight of the isocyanate component of monomeric MDI and from 40 to 60 wt. %, based on the weight of the isocyanate component, of a polymeric MDI and a diol.

In accordance with the foam forming reaction mixture of the present invention, wherein the polyol component may comprise from 55 to 70 wt. %, or, preferably, from 58 to 67.5 wt. % based on the weight of the polyol component, of the one or more, preferably, two or more, first polyols, from 13 to 30 wt. %, or, preferably, from 14 to 27 wt. % based on the weight of the polyol component, of the one or more high molecular weight polyols.

In accordance with the foam forming reaction mixture of the present invention, wherein the catalyst in the polyol component comprises an amine catalyst, such as, for example, a reactive amine catalyst, in the amount of from 0.1 to 1 wt. %, based on the total weight of the polyol component. An example of an amine catalyst is a tertiary amine, for example, bis (N,N-dimethylaminoethyl) ether. As used herein a “reactive amine catalyst” refers to one that contains at least one tertiary amino group and at least one isocyanate-reactive group, such as a hydroxyl, primary amino or secondary amino group, and which reacts with the polymer structure as the reaction mixture cures. A foam cell regulator can also serve as the catalyst.

In accordance with the foam forming reaction mixture of the present invention, wherein the polyol component may further comprise any of an amine gelation catalyst, for example, a nonvolatile catalyst, such as a diazo bicyclooctane. Such amine gelation catalysts may be present in the amount of from 0.1 to 1 wt. %, based on the total weight of the polyol component.

In accordance with the foam forming reaction mixture of the present invention, wherein the polyol component further comprises a foam cell regulator, such as iminodiethanol (DEOA). Such foam cell regulators may comprise from 0.3 to 0.7 wt. %, based on the total weight of the polyol component.

In accordance with the foam forming reaction mixture of the present invention, wherein the polyol component further comprises one or more additives chosen from, a second blowing agent or a colorant.

In accordance with the foam forming reaction mixture of the present invention, wherein the isocyanate component further comprises one or more additives chosen from, a chain extender or a colorant.

In another aspect of the present invention, a flexible polyurethane foam, in the form of a foamed polycarbamate, comprises an open celled foam that may have a gross density (DIN EN ISO 845) of, for example, from 200 to 280 g/l, or, preferably, from 200 to 260 g/l, and may comprise an aromatic polycarbamate containing two or more aromatic or phenyl groups, and from 6 to 14 wt. %, or, preferably, from 7 to 13 wt. %, based on the weight of the foamed polycarbamate, of an aromatic phosphorus containing flame retardant, preferably, a triaryl phosphorous containing flame retardant containing three phenyl or aromatic groups, and, further, may comprise, in the form of a polycarbamate ester, a polyol which is a mixture of one or more, preferably, two or more, first polyols having an average of from 2.4 to 3.5 hydroxyl groups and a hydroxyl number according to ASTM D4274 of from 26 to 44 mg KOH/g, or, for example, from 30 to 40 mg KOH/g, or, from 32 to 37 mg KOH/g, for example, an ethylene oxide (EO) endcapped triol (e.g. glycerine) initiated propoxylated polyol, and one or more high molecular weight polyols having an average of from 1.8 to 6, or, preferably, from 3 to 5.2 hydroxyl groups and a hydroxyl number according to ASTM D4274 of from 27 to 38 mg KOH/g, or, for example, 31 to 34 mg KOH/g, for example, an EO endcapped triol and sugar alcohol initiated propoxylated polyether polyol, and a flame retardant in the amount of from 3.7 to 9 wt. %, or, preferably, from 4.5 to 8.5 wt. %, based on the weight of the foamed polycarbamate, of a flame retardant halogenated polyether polyol, preferably, a brominated polyether flame retardant having a bromine content of from 30 to 40 wt. % and having, in the form of a carbamate ester, an average hydroxyl functionality of from 2.3 to 3.5.

The flexible polyurethane foam in accordance with the present invention may be formed from any of the preferred reaction mixtures of the present invention, especially wherein the aromatic phosphorus containing flame retardant is a triaryl phosphorous containing flame retardant containing three phenyl or aromatic groups, or, more preferably, a C₁ to C₄ alkyl groups containing triaryl phosphorous containing flame retardant, for example, an isopropyl triphenyl phosphate.

In another aspect, in accordance with the present invention, methods of making a flexible polyurethane foam may comprise mixing an isocyanate component and a polyol component to form a reaction mixture and allowing the reaction mixture to foam, wherein the isocyanate component comprises one or more aromatic polyisocyanate containing two or more aromatic or phenyl groups, and from 12 to 27 wt. %, or, preferably, from 14 to 25 wt. %, based on the weight of the isocyanate component, of an aromatic phosphorus containing flame retardant, preferably, a triaryl phosphorous containing flame retardant containing three or more phenyl or aromatic groups, and, further wherein, the polyol component comprises a mixture of one or more, preferably, two or more, first polyols having an average of from 2.4 to 3.5 hydroxyl groups and a hydroxyl number according to ASTM D4274 of from 26 to 44, or, for example, from 30 to 40, or, from 32 to 37 mg KOH/g, for example, an ethylene oxide (EO) endcapped triol (e.g. glycerine) initiated propoxylated polyol, and one or more high molecular weight polyols having an average of from 1.8 to 6, or, preferably, from 3 to 5.2 hydroxyl groups and a hydroxyl number according to ASTM D4274 of from 27 to 38, or, for example, 31 to 34 mg KOH/g, for example, an EO endcapped triol and sugar alcohol initiated propoxylated polyether polyol, a flame retardant in the amount of from 7.5 to 17.5 wt. %, or, preferably, from 9 to 16.5 wt. %, of a flame retardant halogenated polyether polyol, preferably, a brominated polyether flame retardant having a bromine content of from 30 to 40 wt. % and having an average hydroxyl functionality 2.3 to 3.5, one or more catalysts, and one or more blowing agents, preferably, water. The total amount of the one or more blowing agents may range from 1.0 to 1.3 wt. %, or, preferably, from 1.1 to 1.3 wt. %, based on the total weight of the polyol component of the reaction mixture. The foam reaction may take place in a mold or outside of a mold. The relative amounts of the isocyanate component and the polyol component in the reaction mixture may be sufficient to provide an isocyanate index of from to 1.15, or, preferably, from 0.89 to 1.13, or, more preferably, from 0.91 to 1.12.

### DETAILED DESCRIPTION OF THE INVENTION

In accordance with the present invention, an open cell, non self-skinning flexible polyurethane foam enables the production of engine encapsulation parts and does not drip or burn in presence of an ignition source. The flexible polyurethane foam has a density ranging from 200 to 280 kg/m 3 and may be made from a reaction mixture comprising only liquid flame retardants so that it has excellent physical properties. The flexible polyurethane foam may be formed from a reaction mixture comprising an aromatic polyisocyanate and a high molecular weight polyol having at least 3 hydroxyl groups. Further, in the reaction mixture, the combination of a flame retardant halogenated polyether polyol in the polyol side with a triaryl phosphorous containing flame retardant added in the isocyanate side enables the flexible polyurethane foams of the present invention to meet demanding fire tests and physical property without the addition of solid flame retardants, such as expandable graphite.

The present invention provides flexible polyurethane foams that upon burning create a char that prevents dripping of the foam. The presence of phosphorus aids in extinguishing the flame. In addition, the flexible polyurethane foams in accordance with the present invention pass the commonly influential U.S. Department of Transportation (DOT) Federal Motor Vehicle Safety Standard (FMVSS) 302 for Flammability of Interior Materials-Passenger Cars, Multipurpose Passenger Vehicles, Trucks, and Buses or MVSS 302. Further, the flexible polyurethane foam of the present invention meets one or more, or all of the compression stress resistance, tensile strength and 50% compression set tests of at least one major automobile manufacturer, both initially and after heat and/or humidity exposure.

All ranges recited are inclusive and combinable. For example, a disclosed proportion of comprising 1.8 wt. % or more, for example, up to 5 wt. %, or from 2 to 4 wt. %, based on the total weight of monomers used to make the copolymer, of an ethylenically unsaturated acid functional group containing monomer in copolymerized form, would include proportions of from 1.8 to 5 wt. %, or of from 1.8 to 2 wt. %, or of from 1.8 to 4 wt. %, or of from 2 to 4 wt. %, or of from 2 to 5 wt. %, or of from 4 to 5 wt. %.

Unless otherwise indicated, all temperature and pressure units are room temperature and standard pressure and all humidity conditions are, a relative humidity of 30%.

Unless otherwise indicated, any term containing parentheses refers, alternatively, to the whole term as if parentheses were present and the term without them, and combinations of each alternative. Thus, as used herein the term, “(meth)acrylate” and like terms is intended to include acrylates, methacrylates and their mixtures.

As used herein, the term “ASTM” refers to publications of ASTM International, Conshohocken, Pa.

As used herein, the term “component” refers to a composition containing one or more ingredients which is combined with another component to start a reaction, polymerization, foam formation or cure. Components are kept separate until combined at the time of use or reaction.

As used herein, the term “DIN” refers to publications of the Deutsches Institut fur Normung, the German Institute for Standardization, Berlin, Germany.

As used herein, the term “ISO” refers to the publications of the International Organization for Standardization, Geneva, CH.

As used herein, unless otherwise indicated, the term “isocyanate index” refers to the ratio of the number of equivalents of isocyanate functional groups to hydroxyl groups or active hydrogen groups in a given polyurethane forming reaction mixture, multiplied by 100 and expressed as a number. For example, in a reaction mixture wherein the number of equivalents of isocyanate equals the number of equivalents of active hydrogen, the isocyanate index is 100. As used herein, the term “weight average molecular weight”, refers to that determined by 13C-NMR molecular identification and gel permeation chromatography (GPC), calibrated using a polyether polyol, such as polyethylene glycol.

As used herein, the term “polyisocyanate” refers to an isocyanate group containing material having two or more isocyanate functional groups, such as a diisocyanate, or a biuret, allophanate, isocyanurate, carbodiimide, dimer, trimer or oligomer thereof made by reaction of an excess of isocyanate with one or more diols.

As used herein, the term “total solids” or “solids” refers to everything in a given composition other than water and volatile solvents which flash off or volatilize at below 40° C. and atmospheric pressure.

As used herein, the phrase “wt. %” stands for weight percent.

As used herein, the phrase “vehicle” includes all types of vehicles, such as but not limited to cars, mini vans, SUVs (sports utility vehicle), trucks, semi trucks; tractors, buses, vans, golf carts, motorcycles, bicycles, railroad cars, trailers, ATVs (all terrain vehicle); pickup trucks; heavy duty movers, such as, bulldozers, mobile cranes and earth movers; aircraft; boats; ships; and other modes of transport.

In accordance with the present invention, flexible polyurethane foams may include, for example, semi rigid polyurethane foams having a resiliency of from 40 to 65% as measured according to ASTM D3574-17 (2017). Suitable flexible polyurethane foams may be open cell foams, for example, having a density from 200 to 280 g/l, or, preferably, from 200 to 260 g/l. Suitable flexible polyurethane foams may formed as free-rise foams or molded foams. Open cell foams in accordance with the present invention may comprise cut outs taken from slabs or molded foams wherein the surface other than the skin is an open cell foam.

The flexible polyurethane foam made in accordance with the present invention may be formed from a reaction mixture comprising an isocyanate component of one or more aromatic polyisocyanates containing two or more aromatic or phenyl groups, and an aromatic phosphorus containing flame retardant, preferably, a triaryl phosphorous containing flame retardant containing three or more phenyl or aromatic groups, and a polyol component comprising a mixture of one or more, preferably, two or more, first polyols having an average of from 2.4 to 3.5 hydroxyl groups and a hydroxyl number according to ASTM D4274 of from 26 to 44, or, for example, from 30 to 40, or, from 32 to 37 mg KOH/g, for example, an ethylene oxide (EO) endcapped triol (e.g. glycerine) initiated propoxylated polyol, and one or more high molecular weight polyols having an average of from 1.8 to 6, or, preferably, from 3 to 5.2 hydroxyl groups and a hydroxyl number according to ASTM D4274 of from 27 to 38, or, for example, 31 to 34 mg KOH/g, for example, an EO endcapped triol and sugar alcohol initiated propoxylated polyether polyol, a flame retardant halogenated polyether polyol, preferably, a brominated polyether flame retardant having a bromine content of from 30 to 40 wt. % and having an average hydroxyl functionality of from 2.3 to 3.5, one or more catalysts, and one or more blowing agents, preferably, water. The reaction mixture may contain other reactants.

Suitable aromatic polyisocyanates for making the flexible polyurethane foams of the present invention may include any known di- or poly-aromatic diisocyanates or polyisocyanates having two or more than two phenyl or aryl groups, such as diphenylmethane diisocyanate (MDI) in the form of its 2,4′-, 2,2′-, or 4,4′-isomers and mixtures thereof. Preferably, the aromatic diisocyanates or polyisocyanates having two or more than two phenyl or aryl groups are chosen from crude MDI, polymeric MDI or mixtures thereof, prepolymers thereof, and mixtures containing up to 20 wt. % or other aromatic polyisocyanates. As used herein, the term “crude MDI” or “polymeric MDI” (polymethylene polyphenylene polyisocyanates) refers to mixtures of diphenylmethane diisocyanates and oligomers thereof having an isocyanate functionality greater than 2, and may include known variants of MDI comprising urethane, allophanate, urea, biuret, carbodiimide, uretonimine and/or isocyanurate functional groups. Suitable carbodiimide and/or uretonimine modified polyisocyanates may include those such as are disclosed in U.S. Pat. No. 6,765,034B2 to Nishida et al.

Suitable crude MDI, polymeric MDI, combinations thereof, and/or liquid variants thereof may be obtained by introducing uretonimine and/or carbodiimide groups into MDI by known methods, such as by reacting MDI and/or a carbodiimide thereof with MDI, with a carbodiimide thereof, or with a biuret thereof, allophanate thereof and/or isocyanurate thereof. Other suitable crude MDI, polymeric MDI, combinations thereof, and/or liquid variants thereof may be obtained by reacting MDI and/or its carbodiimide, biuret, allophanate, and/or isocyanurate with up to 10 wt. %, or, preferably, from 2 to 7 wt. % of a diol or oligodiol chain extender, such as propylene glycol, dipropylene glycol or tripropylene glycol to form a carbamate containing aromatic polyisocyanate prepolymer. Suitable prepolymers may be formed from MDI, polymeric MDI or mixtures thereof and diol chain extenders, such as from 2 to 7 wt. % of one or more diols, based on the weight of the reactants used to make the prepolymer. Such suitable crude MDI and/or (pre)polymeric MDI may have an NCO value of from 28 to 33 wt. % and may include from 30 to 60 wt. % of 2,4′-diphenylmethane diisocyanate in the form of a monomer. Preferably, the crude MDI and/or polymeric MDI materials comprise carbodiimide and/or uretonimine modified polyisocyanates having from 30 to 60 wt. % of monomeric MDI, or, more preferably, from 35 to 55 wt. % of monomeric MDI.

A preferred example of a suitable isocyanate component comprises a mixture of from 40 to 60 wt. % of monomeric diphenylmethane diisocyanate (monomeric MDI) in the form of its 2,4′-, 2,2′-, or 4,4′-isomers and from 40 to 60 wt. % of a uretonimine of MDI or another polymeric MDI. More preferably, the mixture of monomeric MDI and polymeric MDI further comprises up to 10 wt. %, or, preferably, from 2 to 8 wt. % of a chain extender chosen from a diol or an oligodiol, such as dipropylene glycol or tripropylene glycol. An example of a commercially available monomeric MDI may be ISONATE™ M 125 isocyanate (The Dow Chemical Co., Midland, MI). An example of a commercially available polymeric MDI may be ISONATE™ M 143 uretonimine (Dow).

In the present invention, the aromatic polyisocyanate in the isocyanate component may include one or more aromatic polyisocyanate or cycloaliphatic polyisocyanate in addition to and/or in place of crude MDI, polymeric MDI, and/or prepolymeric MDI, provided that the other aromatic polyisocyanates do not have adverse influences on the performance on the desired sound deadening and vibration management properties of the polyurethane foam. Typical examples of such other polyisocyanate compounds include isocyanate-terminal prepolymers which are formed by a reaction between at least one of compounds of the above-indicated monomeric MDI, and suitable active hydrogen compounds. To improve the foamability and other characteristics of the obtained foam, the additional polyisocyanates may be chosen from toluene diisocyanates (TDI), isophorone diisocyanates (IPDI) and xylene diisocyanates (XDI), and modified forms or oligomers thereof, such as biurets, alllphanates, carbodiimides, isocyanurates and carbamate containing prepolymers thereof. Suitable additional polyisocyanates may have an average isocyanate functionality of from 2.1 to 3.0, or, preferably, from 2.2 to 2.8.

The phosphorus flame retardant of the isocyanate component may comprise an alkyl substituted aryl phosphate represented by the general structure:

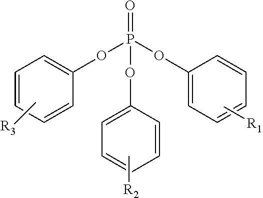

wherein each R, R₂, and R₃ is, independently, a hydrogen or a linear or branched C₁ to C₄ alkyl group. Suitable alkyl substituted aryl phosphates include t-butylated triphenyl phosphate, i-butylated triphenyl phosphate, tricresyl phosphate, isopropylated triphenyl phosphate, and mixtures thereof. Such alkylated triaryl phosphates contain from about 5.5 to 9 wt. % phosphorus, depending on the degree of alkylation. Preferably, the triphenyl phosphates are isopropyl or butyl triphenyl phosphates in which the individual rings contain 0, 1, or 2 butyl or isopropyl groups. An example of a suitable triaryl phosphorous containing flame retardant is REOFOS™ 50 flame retardant (Lanxess, Cologne, DE).

To insure that the flexible polyurethane foam and any drips therefrom are sufficiently self-extinguishing, suitable amounts of the aromatic polyisocyanate used to make the flexible polyurethane foam may be those amounts sufficient to provide an isocyanate index of from 0.86 to 1.15, or, preferably, from 0.89 to 1.12, or, more preferably, from 0.89 to 1.11.

The polyol component of the reaction mixture in accordance with the present invention comprises polyol component which may include any polyol mixture of one or more first polyols having an average of from 2.4 to 3.5 hydroxyl groups and one or more high molecular weight polyols having an average of from 1.8 to 6 hydroxyl groups. The first polyols have a hydroxyl number according to ASTM D4274 of from 26 to 44, or, for example, from 30 to 40, or, from 32 to 37 mg KOH/g and may be, for example, an ethylene oxide (EO) endcapped triol (e.g. glycerine) initiated propoxylated polyol. The high molecular weight polyols may have an average of from 1.8 to 6, or, preferably, from 3 to 5.2 hydroxyl groups according to ASTM D4274 and a hydroxyl number of from 27 to 38, or, for example, 31 to 34 mg KOH/g, and may be, for example, an EO endcapped triol and sugar alcohol initiated propoxylated polyether polyol. Suitable first polyols may have a weight average molecular weight (GPC/NMR) of from 2000 to 6000, suitable high molecular weight polyols may have a weight average molecular weight (GPC/NMR) of from 3000 to 10,000, preferably, from 4,000 to 8,500.

Suitable polyols are known in the prior art and may include reaction products of diols, glycols or alkylene oxides, for example, ethylene oxide and/or propylene oxide, ethylene glycol, diethylene glycol, propylene glycol, dipropylene glycol, or butane diol, with initiators containing from 2.4 to 6 active hydrogen atoms per molecule. Suitable initiators may include triols, for example, glycerol, trimethylolpropane, or triethanolamine, and higher alcohols, such as pentaerythritol, sorbitol and sugar alcohols such as sucrose; and mixtures of such initiators. Other suitable polyols may include polyamines or polyesters obtained by the condensation of diols, glycols or alkylene oxides and higher functionality initiators containing from 2.4 to 6 of from 2.5 to 5.5 active hydrogen atoms per molecule with polycarboxylic acids in proportions to produce polyols having hydroxyl functional groups. Still further suitable polyols include hydroxyl terminated polythioethers, polyamides, polyesteramides, polycarbonates, polyacetals, polyolefins and polysiloxanes, all formed with initiators containing from 2.4 to 5.5 active hydrogen atoms per molecule and diols, glycols or alkylene oxides. Still further suitable polyols may include up to 5 wt. % of extenders chosen from ethylene glycol, diethylene glycol, propylene glycol, dipropylene glycol, butane diol, ethylene diamine, ethanolamine, diethanolamine, triethanolamine and mixtures thereof. Preferably, polyols are used which do not comprise primary, secondary or tertiary nitrogen atoms.

Of particular importance for the preparation of the flexible polyurethane foams of the present invention are polyol mixtures wherein the first polyol has an hydroxyl equivalent weight of from 300 to 2000, and wherein the high molecular weight polyol has an hydroxyl equivalent weight of from 1200 to 3000. As used herein, the term “polyol equivalent weight” or “hydroxyl equivalent weight” is the weight average molecular weight of the polyol divided by the average number of hydroxyl groups or the average hydroxyl functionality of the molecule.

Of particular importance for the preparation of the flexible polyurethane foams in accordance with the present invention are polyol mixtures comprising the reaction products of one or more initiators with diols, glycols, and/or alkylene oxides, for example ethylene oxide and/or propylene oxide, preferably with alkylene oxides. Suitable diols have exactly two hydroxyl groups and a molecular weight of up to 15, or, for example, from 62 to 150, or, from 62 to 125, or, from 62 to 100. Examples of diols include ethylene glycol, 1,2-propylene glycol, 1,3-propylene glycol, 1,4-butane diol, diethylene glycol, thiodiethanol, N-methyldiethanolamine and dipropylene glycol. Suitable initiators may contain from 2.4 to 6 active hydrogen atoms per molecule. Suitable initiators may include, for example, glycerol, trimethylolpropane, triethanolamine, pentaerythritol, sorbitol and other sugar alcohols, such as xylitol or mannitol; and mixtures of such initiators. Other suitable polyols include polyesters obtained by the condensation of appropriate proportions of alkylene oxides, glycols and the initiators with polycarboxylic acids. Still further suitable polyols include hydroxyl terminated polythioethers, polyamides, polyesteramides, polycarbonates, polyacetals, polyolefins and polysiloxanes. Suitable polyols may have an oxyethylene (ethylene oxide or polymerized ethylene glycol) wt. % content of from 10 to 50 wt. %, or, preferably, from 10 to 30 wt. %. A preferred isocyanate-reactive component comprises an ethylene-oxide capped initiator, such as glycerol or a mixture of glycerol and sorbitol.

To obtain the desired molecular weights, the polyols in the present invention may result from the polymerization of propylene oxide onto the initiator, followed by endcapping with ethylene oxide to provide primary hydroxyl groups. Thus, the initiator determines the number of polyether chains that may be ethylene oxide endcapped.

Preferably, the first polyol comprises an ethylene oxide endcapped propoxylated polyol having an average of from 2.4 to 3.5 hydroxyl groups, or, more preferably, three hydroxyl groups such as a glycerol initiated polyol that is ethylene oxide endcapped. Such a polyol may have from 75 to 80% of primary hydroxyl groups, based on the total number of hydroxyl groups. The preferred first polyol may have a weight average molecular weight of from 4200 to 5400.

A preferred high molecular weight polyol may have an average of from 4.5 to 5.4 hydroxyl groups and comprise a sugar alcohol and glycerol initiated propoxylated polyol that is ethylene oxide endcapped. Such a polyol may have from 75 to 80% of primary hydroxyl groups, based on the total number of hydroxyl groups. The preferred high molecular weight polyol may have a weight average molecular weight of from 5000 to 8500.

Another suitable high molecular weight polyol is polyol component Polyols SPECFLEX™ NC 702 polyol (Dow), a styrene acrylonitrile copolymer composition in a polyether polyol carrier with 39 to 43 wt. % solid content, the carrier polyol is a triol initiated, for example, glycerin initiated, propoxylated EO capped polyether polyol having an average hydroxyl number of 20 to 24 mg KOH/g.

For making the flexible polyurethane foams in accordance with the present invention, the polyol mixture may comprise up to 99 wt. %, or, up to 95 wt. %, or, up to 94 wt. % of the polyol component. Further, the polyol mixture may comprise 90 wt. %, or more, or, 92 wt. % or more, based on the total weight of the polyol component in the reaction mixture.

The polyol component of the reaction mixture in accordance with the present invention comprises a flame retardant halogenated polyether polyol, preferably a brominated polyether polyol flame retardant containing an average hydroxyl functionality of from 2.3 to 3.5. Suitable halogenated polyether polyols may comprise the reaction product of a brominated triol or a mixture of a brominated diol and a brominated triol and epichlorohydrin. An example of one such is the flame retardant sold as IXOL™ B-251 polyol (Solvay, Brussels, BE)

Such brominated polyether polyol flame retardant may have the following formula, wherein x plus y equals from 2.3 to 3.5:

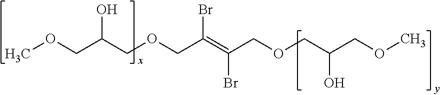

The polyol component of the reaction mixture for making the flexible polyurethane foams of the present invention may further comprise one or more catalyst. Suitable catalysts may be primary amine catalysts, secondary amine catalysts, tertiary amine catalysts, reactive amine catalysts or mixtures thereof, preferably, a tertiary amine catalyst. The catalyst may be any compound possessing catalytic activity for the reaction between a polyol and an aromatic polyisocyanate and at least one amine group. Representative catalysts may comprise tertiary amines, including trimethylamine, triethylamine, dimethylethanolamine, N-methylmorpholine, N-ethyl-morpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl) ether, morpholine, 4,4′-(oxydi-2,1-ethanediyebis, triethylenediamine, pentamethyl diethylene triamine, dimethyl cyclohexyl amine, N-acetyl N,N-dimethyl amine, N-coco-morpholine, N,N-dimethyl aminomethyl N-methyl ethanol amine, N, N, N′-trimethyl-N′-hydroxyethyl bis(aminoethyl) ether, N,N-bis(3-dimethylaminopropyl)N-isopropanolamine, (N,N-dimethyl) amino-ethoxy ethanol, N, N, N′,N′-tetramethyl hexane diamine, 1,8-diazabicyclo-5,4,0-undecene-7, N,N-dimorpholinodiethyl ether, N-methyl imidazole, dimethyl aminopropyl dipropanolamine, bis(dimethylaminopropyl)amino-2-propanol, tetramethylamino bis (propylamine), (dimethyl(aminoethoxyethyl))((dimethyl amine)ethyl)ether, tris(dimethylamino propyl) amine, dicyclohexyl methyl amine, bis(N,N-dimethyl-3-aminopropyl) amine, 1,2-ethylene piperidine and methyl-hydroxyethyl piperazine. A suitable amine catalyst may comprises bis(N,N-dimethylaminoethyl)ether, or a mixture of a bis(N,N-dimethylaminoethyl) ether (70%) and 1,4-diazobicyclo-2,2,2-octane. Examples of reactive amine catalysts include 2-propoxy,1,1′-[[3-(dimethylamino)propyl]imino]bis-, 1,3-propanediamine, N-1-[2-[2[(dimethylamino)ethoxy]ethyl] N-1-methyl,2-[[2-[2-(dimethylamino)ethoxy]ethyl] methylamino ethanol, N-3-[3-(dimethylamino)propyl]-N-1,N-1-dimethyl],3-propanediamine and DEOA.

Examples of amine catalysts useful in the polyol component of the present invention may include those available as DABCO™ NE 300, a N,N,N′-trimethyl-N′-3-aminopropyl-bis(aminoethyl) ether catalyst (Evonik Industries, Inc, Essen, DE), DABCO™ NE 1095 catalyst (Evonik) which is a blend of from 1 to 10 wt. % of N-[2-[2-(dimethylamino) ethoxy]ethyl]-N-methyl-1,3-propanediamine and the remainder of 6-Dimethylaminohexan-1-ol, JEFFCAT™ DMDEE catalyst, 2,2′-dimorpholinodiethylether (Huntsman, The Woodlands, TX), JEFFCAT™ DM-70 catalyst (Huntsman), which is from 63 to 84 wt. % 2,2′-dimorpholinyldiethyl ether, from 13 to 30 wt. % of 1,4-dimethylpiperazine and from 3 to 7 wt. % of 4,4′-(ethane-1,2-diyebismorpholine.

The polyol component of the reaction mixture used to make the flexible polyurethane foams of the present invention may contain one or more secondary catalysts, in addition to an amine catalyst. Of particular interest among these are tin carboxylates and tetravalent tin compounds. Examples of these include stannous octoate, dibutyl tin diacetate, dibutyl tin dilaurate, dibutyl tin dimercaptide, dialkyl tin dialkylmercapto acids, dibutyl tin oxide, dimethyl tin dimercaptide, dimethyl tin diisooctylmercaptoacetate, and the like.

Catalysts may be used in amounts, for example, of from 0.002 to 5 wt. %, or, preferably, from 0.01 to 1 wt. %, based on the total weight of the polyol component. Organometallic catalysts, if used, may be used in amounts of from 0.001 to 0.5 wt. %, based on the total weight of the polyol component.

To allow better hardness control in the foam, a chain extender may be employed as an additional ingredient in the polyol component of the reaction mixture used to make the flexible polyurethane foam of the present invention. Chain extenders may comprise diols, alkoxy diols, or polyols having one or two isocyanate-reactive groups and an equivalent weight per isocyanate-reactive group of up to 499, or, up to 250. Chain extenders, if present at all, are usually used in small amounts, such as up to 10 wt. %, or, preferably, from 1 to 5 wt. %, based on the total weight of the polyol component. Examples of suitable chain extenders include ethylene glycol, diethylene glycol, triethylene glycol, propylene glycol, dipropylene glycol, tripropylene glycol, 1,4-dimethylolcyclohexane, 1,4-butane diol, 1,6-hexane diol, 1,3-propane diol, diethyltoluene diamine, amine-terminated polyethers such as JEFFAMINE™ D-400 polyethers (Huntsman Chemical Company, Salt Lake City, UT), amino ethyl piperazine, 2-methyl piperazine, 1,5-diamino-3-methyl-pentane, isophorone diamine, ethylene diamine, hexane diamine, hydrazine, piperazine, mixtures thereof and the like. A methoxy glycol in the amount of from 1 to 5 wt. %, based on the total weight of the polyol component may enable improved hardness control in the flexible polyurethane foam.

In the reaction mixtures of the present invention, the polyol component may further comprise any of a surfactant, a crosslinker for the aromatic polyisocyanate, a filler, a colorant, a pigment, an antistatic agent, reinforcing fibers, an antioxidant, or a preservative. For example, a colorant may be present in the amount of from 0.5 to 2 wt. %, based on the total weight of the polyol component.

In the reaction mixtures of the present invention, the isocyanate component may further comprise any of a surfactant, a chain extender, a filler, a colorant, a pigment, an antistatic agent, reinforcing fibers, an antioxidant, a preservative, or an acid scavenger.

Polyurethane foam reaction mixtures that contain a mixture of a first polyol, and a high molecular weight polyol in a ratio of from 15 to 35 wt. % of the first polyol and from 65 to 85 wt. % of the high molecular weight polyol, based on the total weight of the first polyol and the high molecular weight polyol, have been found to enable good processing, especially in formulations in which water is used as a blowing agent, especially when used as the sole blowing agent. As used herein, the term “good processing” refers to the effect of using a reaction mixture that consistently produces acceptable quality foams in an industrial setting. Good processing is indicated by a consistency in uniform cell structure, open cell formation, complete mold filling, surface appearance, foam density and physical properties as the foam is produced over time. The reaction mixture should tolerate small changes in operating temperatures, catalyst levels and other process conditions which often cause significant product inconsistencies in high water containing reaction mixtures.

Open celled flexible polyurethane foams in accordance with the present invention can be made in a slabstock process or in a closed mold molding process. Slabstock foam may be formed as a large bun which is cut into the required shape and size for use. Closed mold molding processes can comprise a hot molding process or a cold molding process, wherein the foaming takes place in a closed mold. After the foam has cured, the mold is opened, and the foam removed. If an integral skin is formed onto the surface of the foam in the mold, the skin may be removed such as by cutting.

In accordance with the present invention, methods of making the flexible polyurethane foams comprise forming a reaction mixture which, when mixed, allows for a foaming reaction to occur, by mixing an isocyanate component of one or more aromatic polyisocyanate containing two or more aromatic or phenyl groups, and an aromatic phosphorus containing flame retardant, preferably, a triaryl phosphorous containing flame retardant containing three or more phenyl or aromatic groups, with a polyol component comprising a mixture of one or more, preferably, two or more, first polyols having an average of from 2.4 to 3.5 hydroxyl groups and a hydroxyl number according to ASTM D4274 of from 26 to 44, or, for example, from 30 to 40, or, from 32 to 37 mg KOH/g and one or more high molecular weight polyols having an average of from 3.6 to 6 hydroxyl groups and having a hydroxyl number according to ASTM D4274 of from 27 to 38, or, for example, 31 to 34 mg KOH/g, for example, an EO endcapped triol and sugar alcohol initiated propoxylated polyether polyol, a flame retardant halogenated polyether polyol, preferably, a brominated polyether flame retardant having a bromine content of from 30 to 40 wt. % and having an average hydroxyl functionality of from 2.3 to 3.5, one or more catalysts, and one or more blowing agents, preferably, water, and allowing the resulting reaction mixture to form a foam. The methods may further comprise heating the polyol component up to 40° C., or, to 35° C., or prior to mixing it with the isocyanate component.

In accordance with the flexible polyurethane foams of the present invention, the foam may or may not be crushed to open the cells. An open cell content of at least 25%, or, preferably, at least 50% of cells may provide foams that are suitable for use in noise and vibration absorption applications.

The flexible polyurethane foam of the present invention may have one or more, or, preferably, all of a compression stress resistance (DIN EN ISO 3386-1 (1986)) of from 15 to 100 kPa and at least 50% of this value after heat aging at 168 h at 150° C. or after aging for 200 h at 90° C. and 95% relative humidity; a tensile strength (DIN EN ISO 1798 (1997)) of at least 150 kPa and at least 40% of this value after heat aging at 168 h at 150° C. or after aging for 200 h at and 95% relative humidity; and, a 50% compression set (DIN EN ISO 1856 (2007)) after 22 h at 150° C. of at least 60% of the original compression set.

Depending on the composition of the polyol component, elevated temperatures, above 40° C., may be desired to form the reaction mixture. Preferably, the polyol component is mixed with the isocyanate component at a temperature of less than 40° C., or, more preferably, from 20 to 30° C. The polyol component and the isocyanate component may be mixed together by any known urethane foaming equipment.

The resulting reactive formulation is subjected to conditions sufficient to cure the reactive formulation to form a flexible polyurethane foam. The reactive formulation is either introduced into a suitable mold, so that a foaming/curing reaction takes place within the mold to form the desired polyurethane foam or it is allowed to foam/cure to form a slab stock, or it is foamed in place.

The self-extinguishing flexible polyurethane foams of the present invention may suitably be used for heat intensive applications, such as noise and vibration-absorbing applications, for example, for a vehicle for acoustic insulation of an engine compartment, a fuel injector, an oil pan, an under cover, a hood silencer, a seat cushion, a bulkhead, a door, a roof, or a dashboard. Further, the flexible polyurethane foams may be used for and/or molded into an article to be used for and/or molded/foamed in place as an engine cover, an engine noise insulator, a fuel injector encapsulant, a side cover, an oil pan cover, an under cover, a hood silencer, and a dashboard silencer, to reduce the amount of sound or noise transmitted within the passenger compartment of the vehicle. Further, the flexible polyurethane foams may be suitably used and/or molded into articles to be used for or molded/foamed in place as spacers or fillers for filling gaps or spaces between the passenger cab or fuselage and the engine or surrounding vehicle parts, such as tires, wheels or wings, or for the encapsulation of engine parts or jets for heat insulation and/or for attenuating waves or noise radiating from the engine block, gearbox, differential, exhaust system, radiator fan, engine silencer, propeller or jet.

### EXAMPLES

The following examples are used to illustrate the present invention. Unless otherwise indicated, all temperatures are ambient temperatures (21-23° C.), all pressures are 1 atmosphere and relative humidity (RH) is 35%. Notwithstanding that the numerical ranges and parameters setting forth the broad scope of the invention are approximations, numerical values set forth in the specific examples are reported as precisely as possible. Any numerical value inherently contains certain errors necessarily resulting from the standard variation found in their respective testing measurements.

The materials used in the Examples, below, are set forth in Table 1, below. Each polyol in Table 1, below, has an hydroxyl equivalent molecular weight (HEW), functionality (F) of the number of hydroxyl groups in a given polyol, weight % of ethylene oxide (% EO), and an initiator. As used herein the term “HEW” refers to the hydroxyl equivalent weight of a polyol. Each polyol is made by the reaction of a polyol initiator, which may be a glycol, triol or sugar alcohol which determines the functionality of the polyol, and ethylene oxide (EO) and/or propylene oxide (PO). Flexible polyurethane foams were made by mixing the polyol component and the isocyanate component of the reaction mixtures listed in Tables 2 and 3, below, separately in drums and then properly mixed using an automated stirrer.

The production of foam parts was conducted by a high pressure (molding) machine, such as one equipped with a 14 mm FPL (L shaped mixing chamber) mixing head. The reaction mixture of polyols and isocyanates were poured into a 400 mm×500 mm×20 mm mold that was heated by water recirculation and treated with a water based release agent. The temperature of the mold was set at from 55 to 60° C., the pressure was around 140 bar and the temperature around 25-35° C. The indicated compositions were demolded after 2 minutes and then tested as indicated.

Viscosity: Refers to the result obtained at 20° C. using a cone and plate rheometer equipped with a 50 mm plate in accordance with ASTM D4287 (2019). An acceptable viscosity range lies from 1700 to 3000 mPa*s at 20° C.

Free isocyanate content was measured in accordance with ASTM D 5155 (2019).

Gross density (DIN EN ISO 845 (2009)): To measure foam density. Acceptable range is 200 to 275, or, preferably, 200 to 250 Kg/m³ or g/l.

Compression stress (DIN EN ISO 3386-1(2010)): To measure foam hardness in compression. Acceptable ranges are 15-100 kPa. After heat aging 168 h at 150° C. kPa, an acceptable result is ≥50% of average value of the initial condition. After heat and humid aging 200 h at 90° C. and 95% relative humidity, an acceptable result is ≥50% of average value of the initial condition.

Tensile strength and Elongation at Break (DIN EN ISO 1798 (2008)): Acceptable result is ≥150 kPa. After heat aging 168 h at 150° C. kPa, an acceptable result is ≥40% of average value of the initial condition. After heat and humid aging 200 h at 90° C. and 95% relative humidity, an acceptable result is ≥40% of average value of the initial condition.

50% Compression set (DIN EN ISO 1856(2018))≤60% of initial condition after 22 h at 150° C.

TABLE 1
Flexible Polyurethane Foam Composition Ingredients

| Ingredient | Composition |
|---|---|
| Polyol 1 | Trifunctional polyol made from propoxylated glycerol endcapped with 17.2 wt. % |
| | ethylene oxide, having an F of 3, and an HEW of 1600. OH # 34-37 mg KOH/g. |
| High MW | Polyfunctional propoxylated glycerol and sorbitol endcapped with 15 wt. % ethylene |
| Polyol 1 | oxide, having an F of 4.7 and an HEW of 1700. OH # 30-35 mg KOH/g. |
| Polyol 2 | Trifunctional polyol made from propoxylated glycerol, having an F of 3, and an HEW |
| | of 146. |
| Bromo Fire | Brominated aliphatic polyether triol made from dibromobutene diol and |
| Retardant 1¹ | epichlorohydrin and is a blend of two products: 93.5% of halogenated polyether polyol |
| | (6.5% of TEP cas N. 78-40-0) having a HEW of 170, and an average hydroxyl |
| | functionality of 2.5. Br content of 32.5 wt. % |
| Bromo Fire | Brominated aliphatic polyether diol made from dibromo butene diol and |
| Retardant 2² | epichlorohydrin and having a HEW of 234, and an average functionality of 2.0. |
| Colorant³ | Black paste |
| Catalyst 1⁴ | Bis(N,N-dimethylaminoethyl)ether (70 wt. %) in Dipropylene Glycol |
| Catalyst 2⁵ | 1,4-Diazabicyclooctane |
| Foam Cell | Diethanolamine or iminodiethanol |
| Regulator/ | |
| Reactive | |
| Catalyst | |
| Isocyanate 1⁶ | A prepolymer from 50 wt. % ISONATE ™ M 125 monomeric MDI containing no more |
| | than 2.8 wt. % of o- or p- MDI (free NCO content 33.6 wt. %); 44 wt. % of ISONATE ™ |
| | M 143 (polymeric MDI) uretonimine modified carbodiimide adduct of 4-4′ MDI |
| | containing 70 wt. % of 4-4′MDI (free NCO = 28.9 wt. %); viscosity 30-45 mPa · s; 3.2 |
| | wt. % of tripropylene glycol; and 2.8 wt. % of dipropylene glycol. |
| Phosphorous | Isopropylated triaryl phosphate |
| Flame | |
| Retardant⁷ | |

¹IXOL ™ B-251 retardant (SOLVAY, Brussels, BE);
²IXOL ™ M-125 Retadant (SOLVAY);
³NERO REPITAN/IN 99375 Repi SPA (Maggiore, IT);
⁴NIAX ™ A1 catalyst (Momentive Performance Chemicals, Philadelphia, PA);
⁵DABCO ® 33-LV catalyst (Evonik, Essen, DE);
⁶Dow;
⁷REOFOS ™ 50 retardant (Lanxess, Cologne, DE).

Flammability (MVSS 302) and Self-Extinguishing Fire or Drip Test (PV 3357, Volkswagen, Wolfsburg, D E, 2017):

Measures flammability via the response of a block of foam to surface and edge flame exposure with a Bunsen burner; also, measures self-extinguishing via a drip test. Prior to testing, the blocks were conditioned for 7 d @ 23±2° C. and 50±5% RH. In the flammability test, a 230×230×22 mm block was clamped in a horizontal clamping position and a burner with a flame height of 100 mm was set in the vertical position under the block. The distance between the top of the burner and the block surface is 90 mm. The test is divided into a short-term exposure of 15 seconds and a long-term flame exposure of 5 min. After each exposure, the gas supply is shut off and the specimen is evaluated. In the flammability test, the foam can have burned through, but must not drip or continue to burn once the flame is removed. is recorded as seconds to self-extinguish Regardless of the flame exposure time, the damaged area must not have a diameter greater than 150 mm. If the foam drips during burning, then the drip test is conducted wherein a foam block of a minimum size of 160 mm×200 mm×22 mm is clamped into a horizontal position over a cotton ball layer, the burner is placed at a 45° angle relative to the block and the flame height is controlled in such a way that the flame penetrates the block by 10 mm. The layer of the ball of 10±5 g of 100% absorbent cotton has been manually fluffed and distributed evenly in an open tempered glass cylinder having an inside diameter of 100 mm, and then subjected to a load for 1 min using a 5-kg round plunger. After the load is removed, the cotton layer is placed ˜140 mm centimeters under the foam block. The foam block is then burned for 15 s. The molten drops must not ignite the cotton ball. Three trials of each test were conducted for each foam tested the results were averaged. The self-extinguish time, or the amount of time until any foam continues to burn after the flame is removed, is recorded.

TABLE 2
Fire Tests and Foam Formulations

| | | | | | |
|---|---|---|---|---|---|
| EXAMPLE | A | B | C | D | E |

POLYOL
Component

| POLYOL 1 | 61.5 | | | 66.5 | | | 61.5 | | | 66.5 | | | 61.5 | | |
|---|---|---|---|---|---|---|---|---|---|---|---|---|---|---|---|
| High MW polyol 1 | 20 | | | 20 | | | 20 | | | 20 | | | 20 | | |
| Bromo Fire | 15 | | | 10 | | | 15 | | | 10 | | | 15 | | |
| Retardant 1 | | | | | | | | | | | | | | | |
| Colorant | 1.1 | | | 1.1 | | | 1.1 | | | 1.1 | | | 1.1 | | |
| Catalyst 1 | 0.3 | | | 0.3 | | | 0.3 | | | 0.3 | | | 0.3 | | |
| Catalyst 2 | 0.4 | | | 0.4 | | | 0.4 | | | 0.4 | | | 0.4 | | |
| DEOA | 0.5 | | | 0.5 | | | 0.5 | | | 0.5 | | | 0.5 | | |
| WATER | 1.2 | | | 1.2 | | | 1.2 | | | 1.2 | | | 1.2 | | |
| ISOCYANATE | | | | | | | | | | | | | | | |
| Component | | | | | | | | | | | | | | | |
| Isocyanate 1 | 76 | | | 76 | | | 80 | | | 80 | | | 85 | | |
| Phosphorous Fire | 24 | | | 24 | | | 20 | | | 20 | | | 15 | | |
| Retardant | | | | | | | | | | | | | | | |
| TOTAL | 100 | | | 100 | | | 100 | | | 100 | | | 100 | | |
| ISO INDEX | 90 | 100 | 110 | 90 | 100 | 110 | 90 | 100 | 110 | 90 | 100 | 110 | 90 | 100 | 110 |
| PV 3357 drip test¹ | P | P | P | F | P | P | P | P | P | F | P | P | F | P | P |
| seconds to self- | 18 ± | 19 ± | 16 ± | | 28 ± | 22 ± | 24 ± | 24 ± | 18 ± | | 40 ± | 28 ± | | 34 ± | 35 ± |
| extinguish DRIP | 2 | 2 | 2 | | 4 | 2 | 4 | 6 | 2 | | 9 | 8 | | 7 | 8 |
| [PV3357] | | | | | | | | | | | | | | | |
| MVSS 302 fire test¹ | P | P | P | P | P | P | P | P | P | P | P | P | P | P | P |

¹P = pass; F = fail.

TABLE 3
Comparative Flexible Foam Formulations

| Example | F | | | G | | | H | | | I | | | J | | | K | | |
|---|---|---|---|---|---|---|---|---|---|---|---|---|---|---|---|---|---|---|
| Internal Run | HPM-AS-181 | | | HPM-AS-78 | | | HM-AL-8B | | | HM-AL-7C | | | HM-AL-8E | | | HM-AL-8D | | |
| Number | | | | | | | | | | | | | | | | | | |
| POLYOL SIDE | | | | | | | | | | | | | | | | | | |
| POLYOL 1 | 66.5 | | | 61.5 | | | 61.5 | | | 61.5 | | | 71.5 | | | 76.5 | | |
| High MW | 20 | | | 20 | | | 20 | | | 20 | | | 20 | | | 20 | | |
| polyol 1 | | | | | | | | | | | | | | | | | | |
| POLYOL 2 | | | | | | | 15 | | | | | | | | | | | |
| Bromo Fire | 10 | | | 15 | | | 0 | | | 0 | | | 5 | | | | | |
| Retardant 1 | | | | | | | | | | | | | | | | | | |
| Bromo Fire | | | | | | | | | | 15 | | | | | | | | |
| Retardant 2 | | | | | | | | | | | | | | | | | | |
| Colorant | 1.1 | | | 1.1 | | | 1.1 | | | 1.1 | | | 1.1 | | | 1.1 | | |
| Catalyst 1 | 0.3 | | | 0.3 | | | 0.3 | | | 0.3 | | | 0.3 | | | 0.3 | | |
| Catalyst 2 | 0.4 | | | 0.4 | | | 0.4 | | | 0.4 | | | 0.4 | | | 0.4 | | |
| DEOA | 0.5 | | | 0.5 | | | 0.5 | | | 0.5 | | | 0.5 | | | 0.5 | | |
| WATER | 1.2 | | | 1.2 | | | 1.2 | | | 1.2 | | | 1.2 | | | 1.2 | | |
| ISOCYANATE | | | | | | | | | | | | | | | | | | |
| SIDE | | | | | | | | | | | | | | | | | | |
| Isocyanate 1 | 85 | | | 100 | | | 76 | | | 76 | | | 76 | | | 76 | | |
| Phosphorous | 15 | | | 0 | | | 24 | | | 24 | | | 24 | | | 24 | | |
| Fire Retardant | | | | | | | | | | | | | | | | | | |
| TOTAL | 100 | | | 100 | | | 100 | | | 100 | | | 100 | | | 100 | | |
| ISO INDEX | 90 | 100 | 110 | 90 | 100 | 110 | 90 | 100 | 110 | 90 | 100 | 110 | 90 | 100 | 110 | 90 | 100 | 110 |
| PV 3357 fire | F | F | F | F | F | F | F | F | F | F | F | F | F | F | F | F | F | F |
| test | | | | | | | | | | | | | | | | | | |

1. P = pass; F = fail.

As shown in Table 2, above all inventive flexible polyurethane foams enabled passing results in the self-extinguishing fire test, including self-extinguishing drips, at a wide range of flame retardant concentrations. Only example B at an isocyanate index of 90 failed the test where the foam dripped during the flammability test. In contrast, the comparative flexible polyurethane foams failed the self-extinguishing fire test where, as in Comparative Example H, the reaction mixture lacked a brominated polyol. In Comparative Example I, a flexible polyurethane foam from a reaction mixture comprising a brominated polyether polyol flame retardant having an average hydroxyl functionality of 2 failed the self-extinguishing fire test. In Comparative Examples K and L, proportions of the brominated polyether polyol flame retardant below the inventive range failed the self-extinguishing fire test.

1. A flexible polyurethane foam forming reaction mixture comprising:
An isocyanate component of one or more aromatic polyisocyanate containing two or more aromatic or phenyl groups, or a prepolymer thereof, and from 12 to 27 wt. %, based on the weight of the isocyanate component, of an aromatic phosphorus containing flame retardant; and,
a polyol component which is a mixture of one or more first polyols having an average of from 2.4 to 3.5 hydroxyl groups and a hydroxyl number according to ASTM D4274 of from 26 to 44 mg KOH/g, and one or more high molecular weight polyols having an average of from 1.8 to 6 hydroxyl groups and a hydroxyl number according to ASTM D4274 of from 27 to 38 mg KOH/g, and from 7.5 to 17.5 wt. %, based on the weight of the polyol component, of brominated polyether flame retardant having a bromine content of from 30 to 40 wt. %, and having an average hydroxyl functionality of from 2.3 to 3.5, one or more catalysts, and one or more blowing agents in an amount ranging from 1.0 to 1.3 wt. %, based on the total weight of the polyol component of the reaction mixture,
wherein the relative amounts of the isocyanate component and the polyol component in the reaction mixture are sufficient to provide an isocyanate index of from 0.86 to 1.15.

2. The flexible polyurethane foam forming reaction mixture of claim 1, wherein the isocyanate component comprises diphenylmethane diisocyanate (MDI) in the form of its 2,4′-, 2,2′-, or 4,4′-isomers (monomeric MDI), a polymeric MDI which is a uretonimine, allophanate, biuret, or isocyanurate of MDI, an MDI prepolymer, or mixtures thereof.

3. The flexible polyurethane foam forming reaction mixture of claim 2, wherein the isocyanate component comprises a mixture of from 40 to 60 wt. %, based on the weight of the isocyanate component of monomeric MDI and from 40 to 60 wt. %, based on the weight of the isocyanate component of a polymeric MDI.

4. The flexible polyurethane foam forming reaction mixture of claim 1, wherein the isocyanate component comprises a triaryl phosphorous containing flame retardant containing three phenyl or aromatic groups.

5. The flexible polyurethane foam forming reaction mixture of claim 1, wherein the polyol component comprises from 55 to 70 wt. %, based on the weight of the polyol component, of the one or more, first polyols, and from 13 to 30 wt. %, based on the weight of the polyol component, of the one or more high molecular weight polyols.

6. The flexible polyurethane foam forming reaction mixture of claim 5, wherein the high molecular weight polyol has an average of from 3 to 5.2 hydroxyl groups.

7. The flexible polyurethane foam forming reaction mixture of claim 1, wherein the catalyst in the polyol component comprises a primary amine.

8. The flexible polyurethane foam forming reaction mixture of claim 1, wherein the blowing agent comprises water.

9. The flexible polyurethane foam forming reaction mixture of claim 1, wherein the polyol component further comprises any of an amine gelation catalyst in the amount of from 0.1 to 1 wt. %, based on the total weight of the polyol component.

10. A flexible polyurethane foam which comprises an open celled foam, in the form of a foamed polycarbamate, that has a gross density according to D4274DIN EN ISO 845 of from 200 to 280 g/l, and which comprises an aromatic polycarbamate containing two or more aromatic or phenyl groups, and from 6 to 14 wt. %, based on the weight of the foamed polycarbamate, of an aromatic phosphorus containing flame retardant, and, further comprises, in the form of a polycarbamate ester, a polyol which is a mixture of one or more, first polyols having, in the form of a carbamate ester, an average of from 2.4 to 3.5 hydroxyl groups and a hydroxyl number according to ASTM D4274 of from 26 to 44 mg KOH/g, and one or more high molecular weight polyols having, in the form of a carbamate ester, an average of from 1.8 to 6 hydroxyl groups and a hydroxyl number according to ASTM D4274 of from 27 to 38 mg KOH/g, and from 3.7 to 9 wt. %, based on the weight of the foamed polycarbamate, of a brominated polyether flame retardant having a bromine content of from 30 to 40 wt. % and having an average hydroxyl functionality, in the form of a carbamate ester, of from 2.3 to 3.5.
